(19) United States
(12) Patent Application Publication
(10) Pub. No.: US 2026/0318821 A1
(43) Pub. Date: Oct. 15, 2026

(54) A SYSTEM FOR MEASURING THERMAL PROPERTIES OF A MATERIAL BY FREQUENCY-DOMAIN THERMOREFLECTANCE

(71) Applicant: THERMAP SOLUTIONS LTD, Bristol (GB)

(72) Inventors: Roland SIMON, Bristol (GB); James POMEROY, Bristol (GB); Miriam MOWAT, Bristol (GB); Petr VANEK, Llanrhystud (GB); Martin KUBALL, Bristol (GB); Nathawat Poopakdee, Bristol (GB)

(21) Appl. No.: 19/483,617

(22) PCT Filed: May 14, 2023
(86) PCT No.: PCT/GB2023/051263

§ 371 Date: Nov. 12, 2025

(51) Int. Cl. G01N 21/17

(52) U.S. Cl. CPC G01N 21/1717; G01N 21/171; G01N 2021/1725; G01N 2021/1731

(57) ABSTRACT

The present invention relates to a frequency-domain thermoreflectance (FDTR) system 10 for measuring the thermal properties of thermally conductive and/or optically rough materials. The system 10 comprises a pump device 12a configured to emit a continuous-wave laser beam; the laser beam being referred to as a pump beam 41; a signal generator 17 configured to generate a modulation signal 49 to temporally oscillate the intensity of the pump beam 41 emitted from the pump device 12a; and an optical arrangement 20 configured to receive and shape the pump beam 41, and steer the pump beam 41 towards a sample of a material, such that, the pump beam 41 interacts with the sample 46 in use. The system 10 further comprises a measurement apparatus configured to monitor the thermal response of the sample 46 due to interaction with the pump beam 41. The pump beam 41, when incident on a sample, has a spot diameter and a temporal intensity-oscillation sufficient to induce a measurable temperature oscillation in the sample 46 that penetrates to a required depth within the sample 46.

### FIELD OF INVENTION

The present invention relates to a frequency-domain thermoreflectance (FDTR) system and methods for measuring the thermal properties of thermally conductive materials and/or optically rough materials, as well as laterally inhomogeneous, and/or curved surfaces.

### BACKGROUND TO THE INVENTION

Designing and implementing effective heat transfer systems is essential to help prevent overheating and damage to equipment in many different industries. For example, in the electronics industry, decreasing the size of components and increasing power consumption can result in significant amounts of heat accumulating in devices, causing overheating, and reducing performance and lifespan. In the aerospace industry, understanding heat transfer is important for the successful launch and re-entry of spacecraft, in particular for keeping the craft and crew safe from the extreme temperatures experienced, and also to help ensure that aircraft engines operate at optimal temperatures to prevent overheating and damage. Moreover, in the nuclear industry, power plants create a huge amount of heat which must be transferred effectively to help prevent overheating of the fuel rods, thereby maintaining safe and stable operations, and also for creating enough steam to drive the turbines that generate electricity to maximise energy production.

Therefore, understanding the thermal properties of different materials, such as thermal conductivity, can provide valuable information on the best materials to use to efficiently transfer the heat generated during different operations, thereby helping to prevent an accumulation of heat and overheating.

Typical methods to measure the thermal properties of a material include the transient-thermoreflectance method (TTR), which has since been developed into the time-domain thermoreflectance method (TDTR) and the frequency-domain thermoreflectance method (FDTR). These methods are based on the principle that the reflectivity of a material is dependent on the temperature of the material. Typically, a powerful pulsed or modulated laser beam is used to induce a periodic temperature change on an optically smooth surface of the measured material. This periodic temperature change can be monitored by measuring the change in reflectivity of a further laser beam reflected off the surface of the material. Thermal properties may be calculated from the phase, amplitude, or the temporal evolution of the measured periodic surface temperature changes.

The present invention seeks to provide an improved FDTR method for measuring the thermal properties of a material.

### SUMMARY OF THE INVENTION

In accordance with a first aspect of the invention, there is provided a frequency-domain thermoreflectance (FDTR) system for measuring the thermal properties of thermally conductive and/or optically rough materials, the system comprising:
a pump device having an adjustable power output, and configured to emit a continuous-wave laser beam; the laser beam being referred to as a pump beam;
a signal generator configured to generate a modulation signal to temporally vary the intensity of the pump beam emitted from the pump device;
an optical arrangement configured to receive and shape the pump beam, and steer the pump beam towards a sample of a material, such that the pump beam interacts with the sample in use; and,
a measurement apparatus configured to monitor the thermal response of the sample due to interaction with the pump beam;
wherein the pump beam, when incident on a sample, has a spot diameter and a temporal intensity-oscillation sufficient to induce a measurable temperature oscillation in the sample that penetrates to a required depth within the sample.

In embodiments, when incident on the sample, the pump beam can have a spot diameter of at least 50 microns, optionally at least 75 microns, optionally at least 100 microns (0.1 mm), optionally at least 400 microns, or optionally at least 500 microns. In further embodiments, when incident on the sample, the pump beam can have a spot diameter of from 100 microns to 1000 microns (1 mm), optionally from 100 microns (0.1 mm) up to 5000 microns (5 mm), optionally from 400 microns to 700 microns, optionally 500 microns to 1000 microns, optionally greater than 500 microns, or optionally greater than 1000 microns (1 mm).

The pump device can be electrically coupled to a driver. The driver can be electrically coupled to the signal generator. In embodiments, the pump device can comprise a high-power solid state laser. In embodiments, the pump device can comprise a high-power laser diode.

In use, the signal generator can be configured to deliver a modulation signal to the driver, which can modulate the current provided to the pump device, thereby modulating the intensity of the emitted pump beam, and inducing a temperature oscillation within the sample. In embodiments, the frequency of the modulation signal (the modulation frequency) can be variable within a pre-defined range. For example, the pre-defined frequency range can be up to 50 kHz, optionally up to 100 kHz, optionally from 10 Hz up to 10 kHz, or optionally from 10 Hz up to 30 kHz. The frequency may be variable from high to low, or optionally low to high, or optionally in any desired order and direction within the pre-defined range.

The measurement apparatus can comprise:
a probe device configured to emit a further continuous wave laser beam; the further laser beam being referred to as a probe beam; and,
wherein the probe beam is configured to reflect from the sample, the surface reflectance properties of the sample being dependent on the temperature of the sample, such that the temperature oscillations induced within the sample by the pump beam can cause the intensity of the reflected probe beam to vary temporally.

The thermal response of a sample can therefore be monitored by detecting the intensity of the reflected probe beam, and measuring the phase lag of the probe beam intensity oscillations with respect to the pump beam intensity oscillations.

As the modulation frequency is varied within the pre-defined range, pump beams can be generated having different temporal intensity oscillations, and therefore different temperature oscillations can be induced in the sample. The measurement apparatus can be configured to monitor the thermal response of a sample by detecting the intensity of the reflected probe beam, and measuring the phase lag of the probe beam intensity with respect to the pump beam intensity, at a number of different modulation frequencies within the pre-defined range. By analysing the thermal response at a number of different modulation frequencies within the pre-defined range, the thermal properties of the sample can be derived.

The probe device can be configured to emit a probe beam having a smaller spot diameter than the pump beam, when incident on a sample. Alternatively, the probe device can be configured to emit a probe beam having the same or similar spot diameter as the pump beam, when incident on a sample.

In embodiments, the probe beam can be configured to have a spot diameter, when incident on a sample, of up to 10 microns.

In other embodiments, the probe beam can be configured to have a spot diameter, when incident on a sample, of at least 50 microns, optionally at least 75 microns, optionally at least 100 microns (0.1 mm), optionally at least 400 microns, or optionally at least 500 microns. In further embodiments, when incident on the sample, the probe beam can have a spot diameter of from 100 microns to 1000 microns (1 mm), optionally from 100 microns (0.1 mm) up to 5000 microns (5 mm), optionally from 400 microns to 700 microns, optionally 500 microns to 1000 microns, optionally greater than 500 microns, or optionally greater than 1000 microns (1 mm).

Embodiments of the present invention are capable of generating a pump beam having a greater thermal penetration depth, such as more than tens of microns or millimetres below the surface of the sample. Thermal penetration depth is comparable to pump spot diameter, and so the larger the pump spot diameter, the greater the penetration depth. Moreover, the penetration depth is inversely related to the modulation frequency; hence, a pump beam having lower frequency temporal intensity oscillations (i.e., lower modulation frequencies, such as up to 50 kHz) are desirable for measuring the thermal properties of the regions, layers or interfaces located tens or hundreds of micrometres or millimetres underneath the sample surface. Higher frequency temporal intensity oscillations tend to decay too quickly with depth, such that measurable temperature oscillations are only present at or near the surface of the sample, and the remainder of the sample experiences a constant temperature and hence its properties cannot be probed with the help of temperature oscillations. Furthermore, materials having higher thermal conductivity require a higher power pump beam to maintain measurable temperature oscillations at a required depth.

Moreover, embodiments of the present invention are capable of measuring samples having optically rough surfaces. Roughness is typically quantified by the root mean square (or RMS) value, which represents the average height deviation of features from the mean surface level of a sample. A lower RMS value indicates a smoother surface, whilst a higher RMS value indicates a rougher surface. An optically rough surface is defined as having an RMS value comparable to or greater than the wavelength of the probe beam, such that the probe beam is more scattered or diffused upon reflection. An optically smooth surface is defined as having an RMS value significantly less than the wavelength of the probe beam-such as greater than an eighth or a quarter of the wavelength-such that the probe beam is more specularly reflected.

The present invention recognises that current systems and methods for performing frequency-domain thermoreflectance (referred to as “FDTR”) are not suitable for measuring the thermal properties of optically rough surfaces. Typical known probe beams are around 10-12 microns in diameter, and so they will scatter upon reflection from an optically rough surface, and therefore the amount of light that will be reflected and received by a detector is minimal. As such, known systems are only typically capable of measuring samples having optically smooth surfaces.

Embodiments of the present invention are capable of measuring the thermal response of optically rough surfaces by providing a large enough probe beam diameter, such that there will be more light reflected and received by a detector, thereby resulting in more accurate measurements. Larger probe beams can therefore be less sensitive to surface roughness, as they help to average the effect of any surface irregularities on the measurements. Furthermore, larger spot diameters can help to average the effect of any lateral inhomogeneities in the composition of the sample. This can allow for more consistent measurements of a sample, resulting in a more accurate representation of the thermal response of the sample.

Although the present system has been designed to measure the average thermal response and determine the average thermal properties of materials having rough/irregular and/or laterally inhomogeneous surfaces, particularly optically rough surfaces, the system is also capable of analysing many other types of materials, such as bulk (i.e., homogeneous), thin-films (e.g., the thickness of a transducer layer applied to some samples), multilayer materials, and thick materials (e.g., greater than tens of microns), having either optically smooth or optically rough surfaces and/or lateral inhomogeneities, and also curved materials, such as materials having cylindrical, hemispherical, or spherical surfaces. The curved materials may have radii of curvature of at least 0.5 mm, optionally at least 1 mm. In particular, the present system can measure the thermal response and properties of particles, such as whole nuclear fuel particles, for example tri-structural isotropic particle fuel. The system can be configured to analyse structurally whole nuclear fuel particles, that is the particles may be unmodified prior to analysis. The nuclear fuel particles may measure around 1000 microns (1 mm) in diameter.

Some samples of materials may comprise a metal transducer layer extending at least partly across the surface of the sample. There may be an adhesion layer between the transducer and the sample. The adhesion layer may comprise a different metal, which improves the adhesion of the transducer and the heat transfer to the sample. The transducer can be configured to absorb the heat provided by the pump beam, and transfer the heat to the sample, such that the pump beam induces temperature oscillations within the sample via the thin-film. Furthermore, the transducer can be configured to have a high thermo-optic coefficient for a given wavelength of the probe beam, such that the reflectivity is sensitive to temperature.

The amplitude of the thermal response of the sample (the detected intensity oscillations of the reflected probe beam) depends on the power density of the pump beam which is defined by power/spot area (at the point where the pump beam is incident on the sample), and scales with the square of the spot diameter. Since larger pump spot diameters are required to measure thermal properties at a greater thermal penetration depth, a higher power pump beam is therefore required to maintain a power density which provides a measurable temperature oscillation within the sample.

The pump spot diameter, when incident on the sample, can be determined by the configuration of the optical arrangement.

The pump device can have a power output that is adjustable from a low power to a high power. The power output of the pump device can be adjustable from around hundreds of milli-Watts up to tens of Watts. The pump device can be configured to operate at a power high enough to induce a measurable temperature oscillation within the sample at larger pump spot diameters.

The system can comprise a pump beam homogeniser optically coupled to the pump device. The pump beam homogeniser can be configured to receive the pump beam emitted from the pump device. The pump beam can be shaped by steering the pump beam through the optical assembly of the pump beam homogeniser to form a smooth, homogeneous, and circular, pump beam profile. In embodiments, the pump beam homogeniser can comprise:
a first end optically coupled to the pump device; the first end configured to receive the pump beam emitted from the pump device;
a second end optically coupled to the optical arrangement; the second end configured to steer a homogenised pump beam towards the optical arrangement; and,
an optical assembly arranged between the first end and the second end; the optical assembly configured to interact with the pump beam emitted from the pump device to form a homogenised pump beam having a substantially rotationally symmetrical energy intensity distribution upon exiting the pump beam homogeniser via the second end.

In use, the pump beam can interact with the optical assembly of the pump beam homogeniser to average the distribution of modes present in the pump beam, such that the pump beam approaches a substantially rotationally symmetrical energy intensity distribution.

In embodiments, the optical assembly of the pump beam homogeniser can comprise an optical fibre cable. The optical fibre cable may comprise multimode fibres. In use, the optical fibre cable can homogenise and circularise the pump beam as it travels through the optical fibre cable.

The optical fibre cable can comprise undulations located along at least part of the length of the optical fibre cable. The optical assembly can further comprise at least one component having an undulating surface pattern. The component can be arranged to receive and interact with at least part of the optical fibre cable to induce an undulating profile into the shape of the optical fibre cable, whereby the undulations can be configured to interact with the received pump beam to even out the distribution of laser beam modes, thereby forming a homogenised laser beam having a substantially rotationally symmetrical energy intensity distribution upon exiting the pump beam homogeniser via the second end.

The optical fibre cable can be arranged to form at least one defined loop. The optical fibre cable can be arranged to form at least two defined loops, or more than two defined loops, such as three defined loops, optionally four defined loops, or optionally more than four defined loops.

In other embodiments, the optical assembly of the pump beam homogeniser can comprise one or more free-space optical devices arranged to interact with the pump beam to form a homogenised pump beam having a substantially rotationally symmetrical energy intensity distributions upon exiting the pump beam homogeniser via the second end.

In embodiments, the measurement apparatus can comprise a probe beam homogeniser optically coupled to the probe device. The probe beam homogeniser being configured to receive the probe beam emitted from the probe device; and steer the probe beam towards the optical arrangement.

The probe beam homogeniser can comprise:
a first end optically coupled to the probe device; the first end configured to receive the probe beam emitted from the probe device;
a second end optically coupled to the optical arrangement; the second end configured to steer a homogenised probe beam towards the optical arrangement; and,
an optical assembly arranged between the first end and the second end; the optical assembly configured to interact with the probe beam emitted from the probe device to form a homogenised probe beam.

In embodiments, the optical assembly of the probe beam homogeniser can comprise an optical fibre cable. The optical fibre cable may comprise multimode fibres. In use, the optical fibre cable can homogenise and circularise the probe beam as it travels through the optical fibre cable.

The optical fibre cable can comprise undulations located along at least part of the length of the optical fibre cable. The optical assembly of the probe beam homogeniser can further comprise at least one component having an undulating surface pattern. The component can be arranged to receive at least part of the optical fibre cable to induce an undulating profile into the shape of the optical fibre cable, whereby the undulations can be configured to interact with the received probe beam to even out the distribution of laser beam modes, thereby forming a homogenised probe beam having a substantially rotationally symmetrical energy intensity distribution upon exiting the probe beam homogeniser via the second end.

The optical fibre cable can be arranged to form at least one defined loop. The optical fibre cable can be arranged to form at least two defined loops, or more than two defined loops, such as three defined loops, optionally four defined loops, or optionally more than four defined loops.

In other embodiments, the optical assembly of the probe beam homogeniser can comprise one or more free-space optical devices arranged to interact with the probe beam to form a homogenised probe beam having a substantially rotationally symmetrical energy intensity distributions upon exiting the probe beam homogeniser via the second end.

In embodiments, upon exiting the pump and/or probe beam homogeniser, the pump and/or probe beams, respectively, can have a substantially Gaussian energy intensity distribution, or optionally a flat top energy intensity distribution, or optionally any other suitable intensity distribution.

The optical arrangement can comprise a plurality of free-space optical devices, such as mirrors, lenses, and/or beam splitters, which can be configured to receive the pump and/or probe beam from the pump and/or probe beam homogenisers, respectively. The optical arrangement can shape the pump and/or probe beam, and steer the pump and/or probe beam towards a sample. Shaping the pump and/or probe beam can comprise expanding and collimating the pump and/or probe beam.

In some embodiments, particularly embodiments comprising a small probe beam diameter (e.g., around 10 microns or less), the measurement apparatus may not comprise a probe beam homogeniser. As such, the optical arrangement can be configured to receive the probe beam from the probe device and steer the probe beam towards the sample.

The system can additionally comprise an objective tube configured to receive the pump and/or probe beam from the optical arrangement, and steer the pump and/or probe beam towards the sample. The objective tube comprises at least one objective lens configured to focus the pump and/or probe beams onto the sample with the required pump and/or probe spot diameter.

The optical arrangement can be configured to steer the pump beam towards the sample at a first angle of incidence. The optical arrangement can be further configured to steer the probe beam towards the sample at a second angle of incidence. In some embodiments, the first and second angles of incidence can be arranged to be the same (i.e., a co-axial configuration). In other embodiments, the second angle of incidence can be greater than the first angle of incidence (i.e., a split-axis configuration).

In the co-axial configuration, the optical arrangement can be arranged such that the optical paths of the pump and probe beams are combined prior to being steered towards the stage section.

The measurement apparatus can further comprise a photodetector configured to receive the reflected probe beam, and detect the intensity of the reflected probe beam.

The measurement apparatus can further comprise a phase-sensitive detector. The phase-sensitive detector can be electrically coupled to the signal generator. The phase-sensitive detector can be electrically coupled to the photodetector. The phase-sensitive detector can be configured to determine the phase lag of the reflected probe beam intensity with respect to the pump beam intensity.

The phase-sensitive detector may be a multi-channel lock-in amplifier. The phase-sensitive detector may comprise the signal generator. As such, the signal generator may be an internal reference oscillator. Alternatively, the phase-sensitive detector and the signal generator may be arranged as separate components. In such embodiments, the signal generator can take the form of a function generator.

The sample and the objective tube can be relatively moveable in the X-, Y-, and Z-axes to position the sample in the focus of the pump and/or probe beam. In some embodiments, at least the objective tube can be moved with respect to the sample (in some embodiments, the whole system can be moved with respect to the sample). In other embodiments, the sample can be moved with respect to the objective tube.

In embodiments, the system can further comprise a stage section. The stage section can comprise a holder configured to receive a sample. The holder can be disk-shaped. The system can further comprise a bridge structure extending over the stage section. In embodiments, the optical arrangement can be mounted on the bridge structure, and the objective tube is arranged to be positioned above the holder.

In embodiments, the holder can be motorised, such that movement of the holder can be controlled by a motor. The motor can be configured to receive instructions from a computer program to move the holder along the X-, Y-, and Z-axes, to position the sample in the focus of the pump beam. In embodiments, this can be around 20 mm from the end of the objective tube.

The computer program can be installed on a computing device in communication with the system, such as a personal desktop computer (PC) or a laptop. An operator can interact with the computer program via a graphical user interface displayed on the computing device. The computer program can be configured to receive input sample parameters from an operator, instruct the motor to move the holder in the X-, Y-, and Z-axes to position the sample in the focus of the pump beam, receive the thermal response measurements of the sample, determine one or more thermal properties of the sample, and then display the one or more thermal properties on a display device (such as a screen) for viewing by the operator. The computer program can additionally be configured to instruct the signal generator to change the frequency of the modulating signal within the pre-defined range.

The computer program can be configured to instruct the motor to move the holder transversely (in the X-Y plane) with respect to the objective tube during use (or with respect to the pump beam, when incident on the sample), such that a two-dimensional map can be created of the one or more thermal properties of the sample. The two-dimensional map can be displayed on the display device for viewing by an operator.

In embodiments, the system can comprise at least one pump device, or at least two pump devices, or more than two pump devices (such as at least three or at least four pump devices), each configured to emit a pump beam. Each pump device can be connected to the or a signal generator via an associated driver to receive a modulation signal in use. Furthermore, the system can also comprise at least one probe device, or at least two probe devices, or more than two probe devices (such as at least three or at least four probe devices), each configured to emit a probe beam.

Each pump and probe beam may have a different wavelength. As such, the system can be designed to analyse samples having different compositions, or different transducer layers (if present), since different materials respond differently to different wavelengths. The appropriate pump device(s) and probe device(s) can be activated depending on the material being analysed, or the transducer layer applied (if required).

In embodiments, at least part of the system can be mounted on an optical baseplate. The optical baseplate can be coupled to a further baseplate via vibration-isolating feet. The further baseplate can be in communication with the environment, and also any cooling fans present in the system. Such an arrangement of baseplates can help to minimise the effect of any vibrations originating from the environment and/or from cooling fans, which can help to minimise the spread of vibrations to the optical arrangement, thereby helping to prevent any distortion in the measurements due to such vibrations.

According to a second aspect of the invention, there is provided a self-contained frequency domain thermoreflectance unit, the unit comprising:
an enclosure configured to selectively move between an operative position and a non-operative position; and,
the system as described in the first aspect of the invention housed within the enclosure;
wherein in the non-operative position the enclosure can be opened to expose at least part of the system for loading a sample onto the holder; and, in the non-operative position the enclosure completely encapsulates the system.

The enclosure can comprise wall panels and panel gaps. The panel gaps can be configured to provide cooling to the system in use. The enclosure can further comprise a door configured to selectively move between the operative position and the non-operative position.

The enclosure can be a Class 1 interlocked enclosure, such that the system cannot be operated whilst the door is open, and the door cannot open whilst the system is in operation. The system can also shut down if the door is opened during use. Class 1 refers to the fact that the interlocked enclosure reduces the risk that the laser beams can be accessed during normal use, and therefore reduces the risk of an operator experiencing eye damage.

It has been recognised that such a self-contained unit with a Class 1 interlocked enclosure provides improved safety, and can allow an operator to use the system without safety glasses because the laser devices are completely isolated from the operator during use. Such improved safety can allow the system to be used under less restricted conditions.

In accordance with a third aspect of the invention, there is provided a method of performing a frequency-domain thermoreflectance measurement using the system as described in the first or second aspects of the invention. The method comprising:
receiving a sample of a material;
generating a continuous-wave laser beam; the laser beam being referred to as a pump beam;
temporally modulating the intensity of the pump beam, homogenising, and shaping the pump beam, and steering the pump beam onto the sample; wherein the pump beam, when incident on the sample, has a spot diameter and an intensity-oscillation sufficient to induce a measurable temperature oscillation in the sample that penetrates to a required depth within the sample;
generating a further continuous-wave laser beam, the further laser beam being referred to as a probe beam;
reflecting the probe beam from the sample and monitoring the thermal response of the sample by detecting the temporal intensity oscillations of the reflected probe beam; and,
measuring the phase lag of the probe beam intensity oscillations with respect to the pump beam intensity oscillations.

The method can further comprise varying the frequency of the modulation signal within a pre-defined range. For example, the pre-defined frequency range can be up to 50 kHz, or optionally from 10 Hz up to 10 kHz. As the modulation frequency is varied within the pre-defined range, pump beams can be generated having different temporal intensity oscillations, and therefore different temperature oscillations can be induced in the sample.

The method can further comprise monitoring the thermal response of the sample by detecting the intensity of the reflected probe beam, and measuring the phase lag of the probe beam intensity with respect to the pump beam intensity, at a number of different modulation frequencies within the pre-defined range. By analysing the thermal response at a number of different modulation frequencies within the pre-defined range, the thermal properties of the sample can be derived.

The sample can comprise bulk materials (i.e., homogeneous), thin-films (e.g., the thickness of a transducer layer applied to some samples), multilayer materials, and thick materials (e.g., greater than tens of microns), having either optically smooth or optically rough surfaces and/or lateral inhomogeneities, and also curved materials, such as materials having cylindrical, hemispherical, or spherical surfaces. For example, the sample may be whole nuclear fuel particles. That is, the nuclear fuel particles are complete/intact, and may be unmodified prior to analysis.

In accordance with a fourth aspect of the invention, there is provided a computer system configured to determine the thermal properties of a material, the computer system including at least one processor for executing program instructions configured to:
receive properties relating to a sample of a material;
perform the method as described in the third aspect of the invention;
receive the thermal response of the sample, the thermal response comprising the temporal intensity oscillations of the reflected probe beam;
determine at least one thermal property of the sample by comparing the phase lag of the probe beam intensity oscillations with respect to the pump beam intensity oscillations; and,
display the at least one thermal property on a display device for viewing by an operator.

Whilst the invention has been described above, it extends to any inventive combination set out above, or in the following description or drawings.

### BRIEF DESCRIPTION OF THE DRAWINGS

Specific embodiments of the invention will now be described in detail by way of example only and with reference to the following drawings, in which:

FIG. 1 shows a perspective view of a system according to embodiments of the present invention;

FIG. 2 shows a rear perspective view of the FIG. 1 system;

FIG. 3 shows a top view of the FIG. 1 system;

FIG. 4 shows a close-up perspective view of the top of the FIG. 1 system;

FIG. 5 shows a side view of the FIG. 1 system;

FIG. 6 shows a front view of a disk housing a looped optical fibre cable in accordance with embodiments of the present invention;

FIG. 7 shows a perspective view of the disk within the FIG. 1 system;

FIG. 8 shows a close-up view of part of a component for inducing undulations in an optical fibre cable, according to embodiments of the invention;

FIG. 9 shows a perspective view of the FIG. 8 component in use;

FIG. 10 shows a schematic representation of the FIG. 1 system;

FIG. 11 shows a schematic representation of an optical arrangement of the FIG. 1 system;

FIG. 12 shows a schematic representation of a side view of the FIG. 11 optical arrangement;

FIGS. 13a and 13b show an enclosure according to aspects of the present invention;

FIG. 14 shows the FIGS. 13a & 13b enclosure housing the FIG. 1 system, with the door removed;

FIG. 15 shows a schematic representation of a system according to further embodiments of the invention; and, p FIG. 16 shows an example representation of a graphical user interface according to embodiments of the present invention.

### DETAILED DESCRIPTION OF EMBODIMENTS

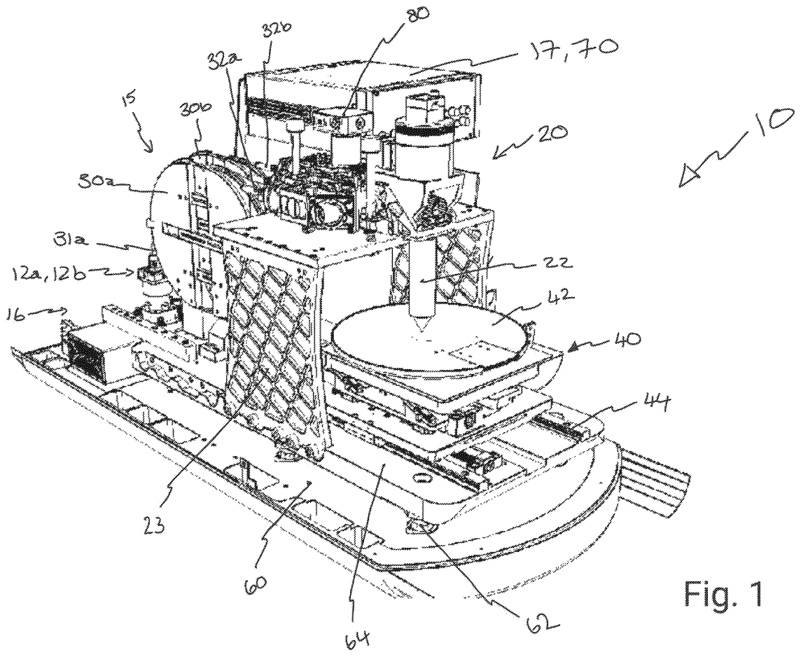

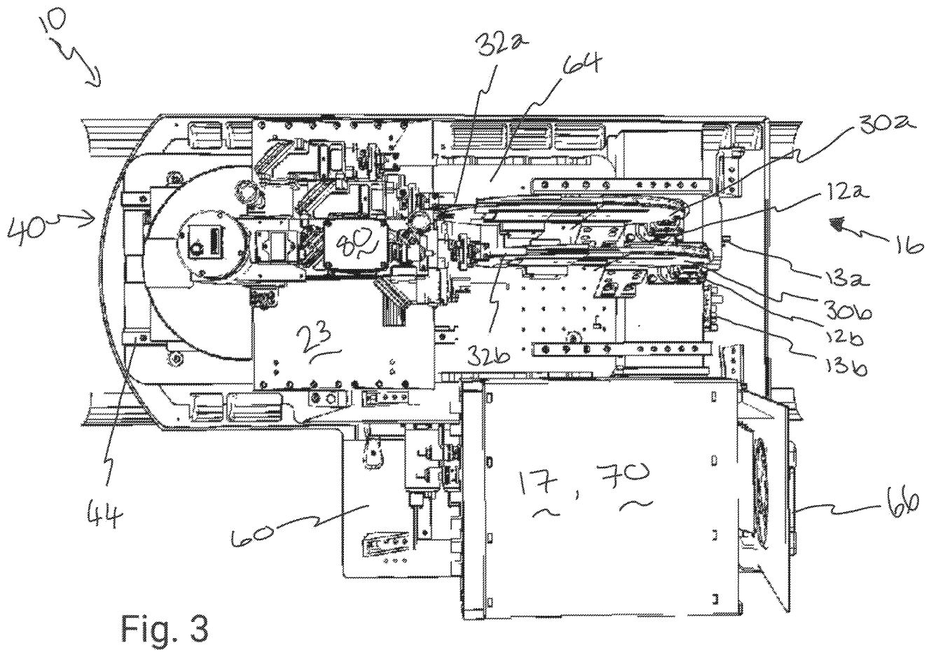

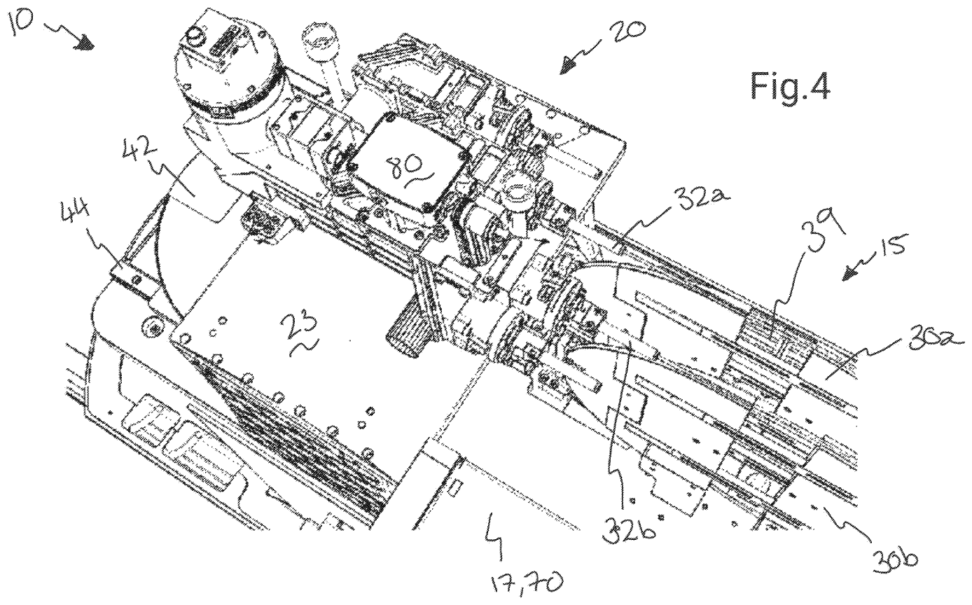

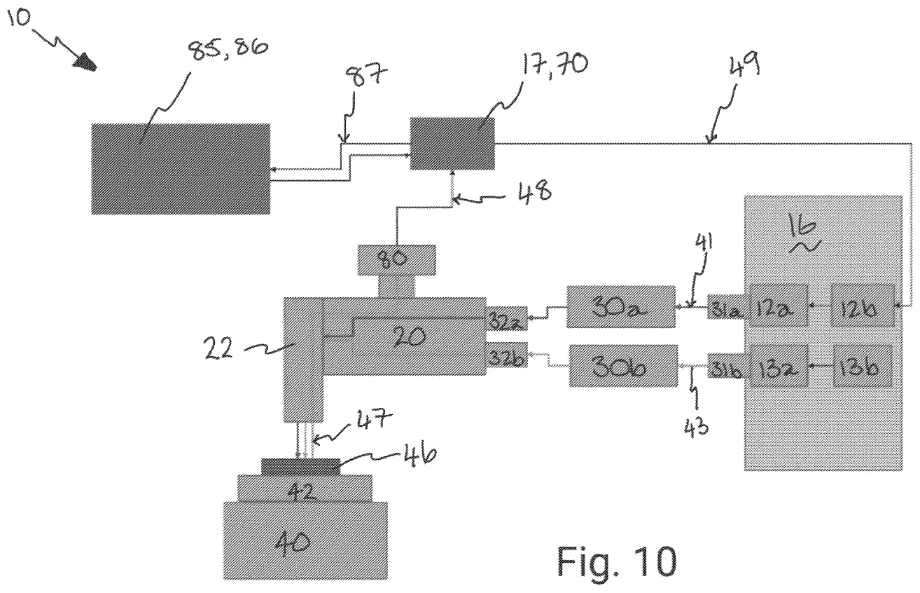

The present invention relates to a system for performing frequency-domain thermoreflectance measurements on samples of thermally conductive materials, and/or materials having lateral inhomogeneities and irregular surfaces (e.g., optically rough surfaces), or curved surfaces, for example, whole nuclear fuel particles, such as tri-structural isotropic particle fuel. Furthermore, the samples can comprise bulk materials, thin-films, multilayer materials, and thick materials (e.g., greater than tens of microns). FIGS. 1-5 show a system 10 for measuring the thermal properties of a thermally conductive material, and/or optically rough and/or multilayer materials. The system 10 comprises two devices in the form of high-power laser diodes 12a, 13a which each emit a continuous-wave laser beam in use. The laser diode 12a is typically a high-power laser diode having an adjustable power output. The laser diode 12a may be referred to as a pump diode, and emits a laser beam referred to as the pump beam 41. The laser diode 13a may be referred to as a probe diode, and emits a laser beam referred to as the probe beam 43. The optical paths of the pump and probe beams 41, 43 are shown in FIG. 10 12.

The pump and probe diodes 12a, 13a are electrically coupled to a pump diode driver 12b and a probe diode driver 13b, respectively. The drivers 12b, 13b are connected to power supply 65. Pump diode driver 12b is electrically coupled to a signal generator 17.

The signal generator 17 is configured to generate and deliver a modulation signal 49 (shown in FIG. 10) to the pump diode driver 12b, which modulates the current provided to the pump diode 12a, and therefore varies the intensity of the pump beam 41 emitted from the pump diode 12a. The signal generator 17 generates a sinusoidal waveform, but in some embodiments, it could generate a square, or other shaped, waveform instead. The pump diode 12a operates at a high power, such that the power output is capable of producing a measurable temperature oscillation within a sample in use. For example, the power output may be up to tens of Watts (W).

In examples, the signal generator 17 can be limited to output a frequency range of from 10 Hz up to 30 kHz. In use, the frequency of the modulation signal can be varied within this range, for example from low frequencies to high frequencies.

The signal generator 17 is part of a phase-sensitive detector 70, which takes the form of a lock-in amplifier. The signal generator 17 may therefore be referred to as an internal reference oscillator.

Typical prior art systems require an electro-optic modulator (EOM) or an acousto-optic modulator (AOM), which is required for the very high modulating frequencies (in the MHz range) needed for measuring very thin films (submicron thickness). However, such high modulation frequencies are not suitable for measuring materials having a thickness upwards of tens of microns, because the temporal temperature oscillations induced by the temporal intensity oscillations of the pump beam tend to decay too quickly with depth, such that measurable temperature oscillations are only present at or near the surface of the sample, and the remainder of the sample experiences a constant temperature, hence its properties cannot be probed with the help of temperature oscillations.

The present invention therefore provides a high-powered pump beam having a lower modulating frequency (in the kHz range) in order to penetrate deeper into the sample (as lower frequency intensity oscillations attenuate more slowly). As such, the present invention does not require an EOM or an AOM, and therefore provides a more cost effective solution over known systems. However, some embodiments of the invention may still utilise an EOM or an AOM to generate the modulation signal.

The system 10 further comprises two beam homogenisers 30a, 30b to independently homogenise the pump and probe beams 41, 43. Beam homogeniser 30a is optically coupled to laser diode 12a, and is configured to receive the pump beam 41, and guide the pump beam 41 from the laser diode 12a to an optical arrangement 20 (described below). Beam homogeniser 30b is optically coupled to laser diode 13a, and is configured to receive the probe beam 43, and guide the probe beam 43 from the laser diode 13a to the optical arrangement 20.

Each beam homogeniser 30a, 30b comprises a first end 31a, 31b and a second end 32a, 32b. The first end 31a is optically coupled to laser diode 12a, and in use, receives an intensity-modulated pump beam 41 emitted from laser diode 12a. The first end 31b is optically coupled to laser diode 13a, and in use, receives a constant intensity probe beam 43 emitted from laser diode 13a.

The second end 32a is optically coupled to the optical arrangement 20, and in use, steers the pump beam 41 towards the optical arrangement 20. The second end 32b is optically coupled to the optical arrangement 20, and in use, steers the probe beam 43 towards the optical arrangement 20.

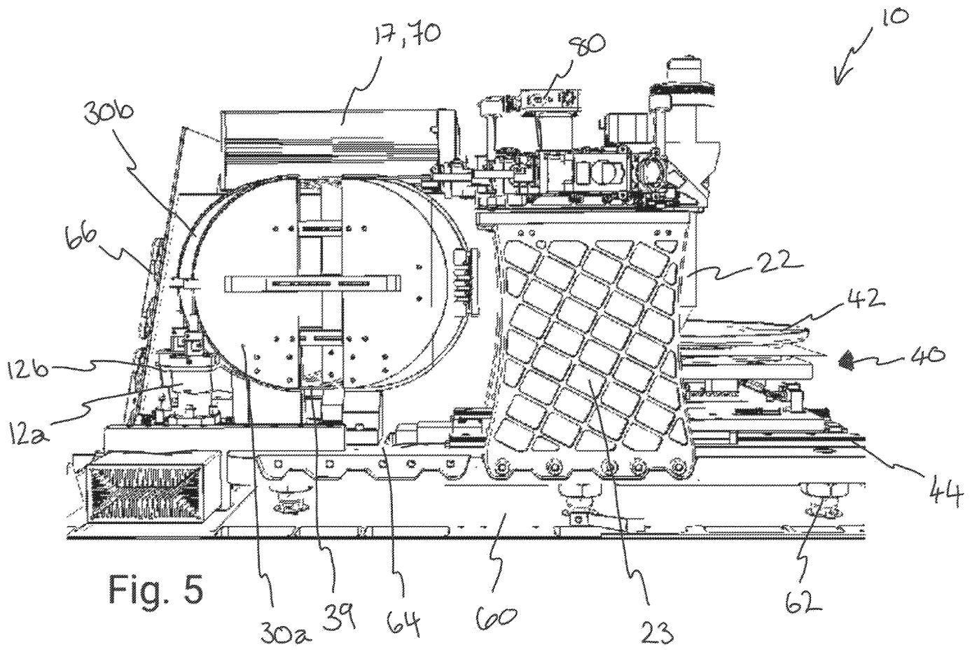

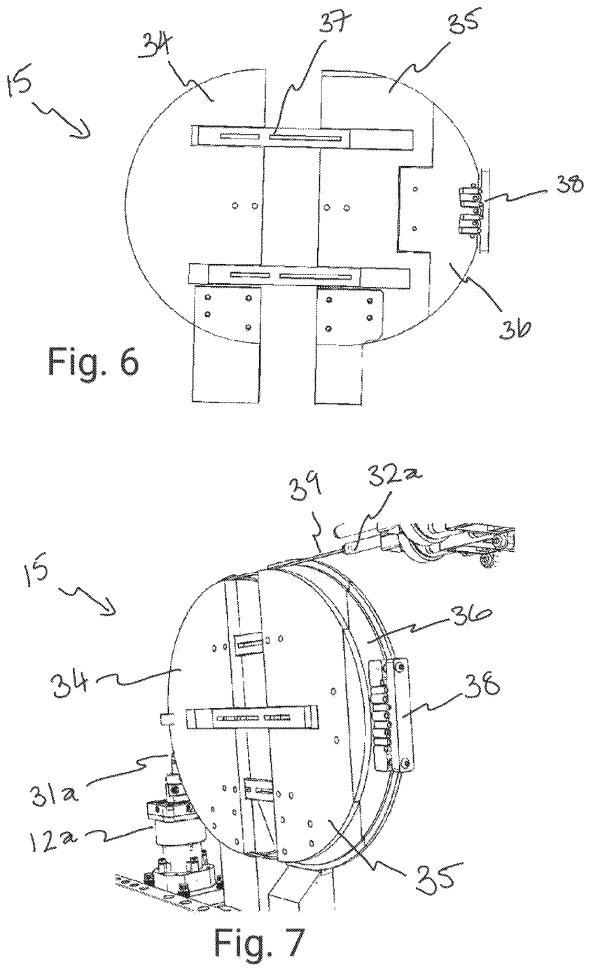

An optical assembly is arranged between the first end 31a and the second end 32a, and also the first end 31b and the second end 32b. Each optical assembly takes the form of a thick multimode optical fibre cable 39 having two defined loops. A component 38 (best shown in FIGS. 5-9) having an undulating surface profile is arranged to be pressed into part of the cable 39 to imprint an undulating profile along part of the length. The looped optical fibre cables 39 are located within large disks 15 positioned at the rear of the system 10 on a heat sink 16, which helps to prevent an accumulation of heat by transferring any generated heat away from the laser diodes 12a, 13a, thereby helping to increase the longevity of the system 10.

As shown in FIG. 6, the disks 15 of each beam homogeniser 30a, 30b are comprised of 3 distinct parts-labelled 34, 35, 36. Parts 34 and 35 are shown in a spaced-apart arrangement, and are configured to slide along rods 37 to vary the width of the gap, such that the beam homogenisers 30a, 30b can accommodate different lengths of fibre cable. Once the appropriate sizing is set, the parts 34, 35 can be secured in place.

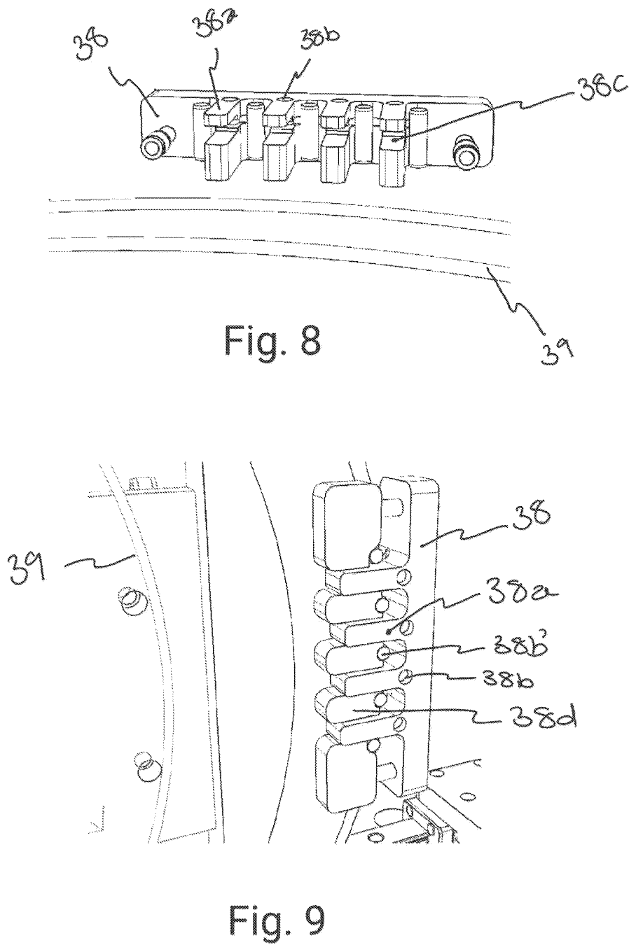

Part 36 is slotted into part 35, and secured in place. Part 36 additionally comprises the component 38 secured to the outer circumference of disk 15. The component 38 is shown in more detail in FIGS. 8 and 9. The component 38 comprises a series of projections 38a and cylinders 38b. Each projection 38a comprises a gap 38c, configured to align with the interior of the disk 15, such that the gap 38c can receive a loop of the fibre optical cable 39.

The projections 38a on either side of the gap 38c are arranged to secure the component 38 to the outside of part 36 via teeth formations 38d on the outer side of disk 15. The component 38 further comprises teeth formations 38d located either side of the disk 15 to interlock with the projections 38a when assembled. Each of the teeth formations 38d comprise cylinders 38b′, which can extend axially from one side of the disk to the other.

During assembly, a loop of the optical fibre cable 39 can be positioned circumferentially along the teeth formations 38d and cylinders 38b′. The projections 38a are then slotted between teeth formations 38d, and secured in place. When assembled, the optical fibre 39 lies within the gap 38c, and is compressed between the cylinders 38b and 38b′, such that the cylinders 38b, 38b′ imprint an undulating profile into the fibre 39.

As such, the optical fibre cables 39 are configured, in use, to interact with the pump and probe beams 41, 43 via the undulations to average the distribution of modes present in the beams. As such, the resulting pump and probe beams 41, 43 are more homogeneous and approach substantially rotationally symmetrical energy intensity distributions upon exiting the beam homogenisers 30a, 30b via the second end 32a, 32b, as compared to the pump and probe beams emitted from the laser diodes 12a, 13a. In use, each optical fibre cable 39 can homogenise and circularise the pump and probe beams 41, 43 as they each travel through the appropriate cable.

The pump and/or probe beams 41, 43 emitted from laser diodes 12a, 13a typically have non-circular (such as elliptical) spot profile, so it is necessary to reshape the beams to form a smooth, homogeneous, and circular beam profiles. This improves beam quality and focus.

The optical arrangement 20 is mounted on a bridge structure 23 located over a stage section 40 which comprises a holder 42. The optical arrangement 20 is configured to receive the pump and probe beams 41, 43 from the second ends 32a, 32b of the beam homogenisers 30a, 30b. The optical arrangement 20 comprises a series of free-space optical devices arranged to collimate and steer the pump and probe beams 41, 43 towards the holder 42, as will be discussed below, as well as to filter any undesired wavelengths from the beams.

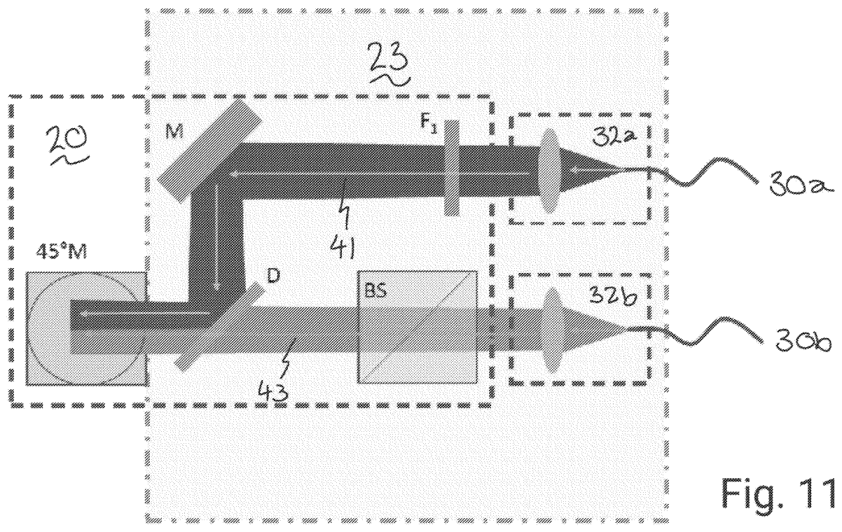

As shown in FIG. 11, the optical arrangement 20 further comprises an optical device D arranged to combine the pump and probe beam paths such that the pump and probe beams 41, 43 are steered along the same (co-axial) path towards the holder 42.

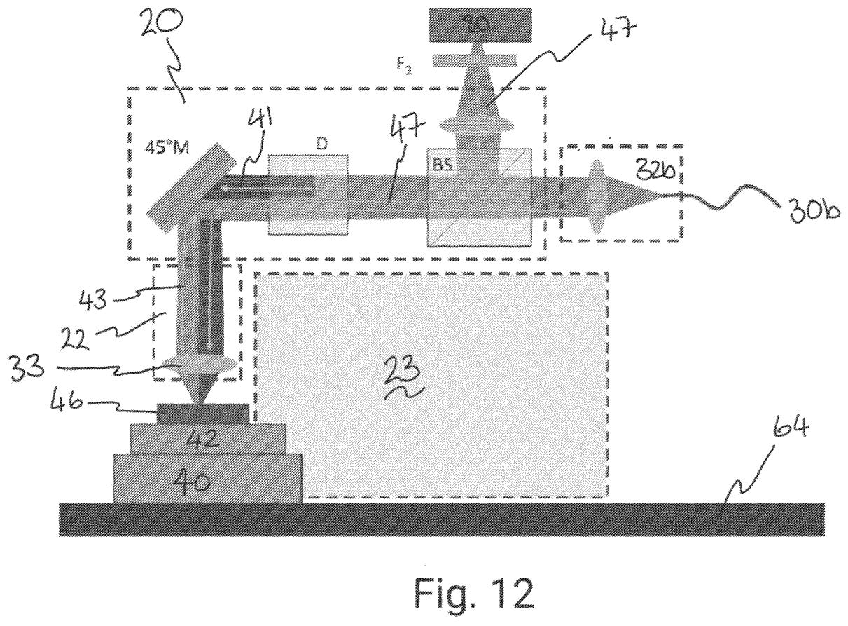

As shown in FIG. 12, the system 10 further comprises an objective tube 22 housing at least one objective lens 33. The co-axial pump and probe beams 41, 43 are, in use, steered from the optical arrangement 20 and into the objective tube 22, for example by steering the co-axial beams through a 90 degree angle. The co-axial beams 41, 43 then travel through the objective tube 22 and objective lens 33, and towards the holder 42. The co-axial beams 41, 43 travel towards the holder 42 at the same angle of incidence, which in this example, is normal to the holder 42.

The objective tube 22 is located at the side of the bridge structure 23, such that in use, the holder 42 can be positioned directly below the objective tube 22. In some examples, the objective tube 22 can comprise a number of objective lenses, each having a different optical power. The objective lenses may be arranged on a carousel, which can be rotated to position a particular objective lens within the objective tube 22 in the path of the beams 41, 43.

The holder 42 is disk-shaped and configured to receive and hold a sample 46 of a material in use. In some examples, the sample may comprise a number of particles, such as whole nuclear fuel particles, measuring up to or around 1000 microns each in diameter. The particles may be mounted on the holder 42 by attaching them to a base with a thermally conductive epoxy or wax.

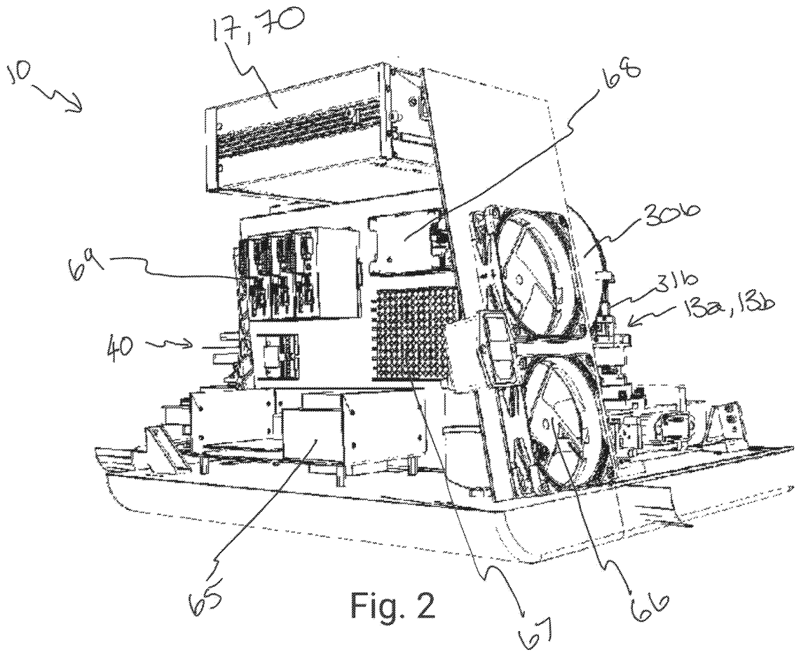

The holder 42 is operatively coupled to a motor (not shown), which, in use, moves the holder 42 in the X-, Y- or Z-directions (that is, horizontally and vertically) to position the sample 46 in the focus of the pump and probe beams 41, 43. The holder 42 is mounted on tracks 44 which allows the holder 42 to be moved along the X-axis by the motor. The stage section 40 can also comprise further tracks (not shown) for moving the holder 42 along the Y- and Z-axes. The motor comprises driver 69 which are connected to a power supply 68, shown in FIG. 2.

If used, the transducer can absorb the heat from the pump beam 41 and transfer the heat to the sample 46, such that the pump beam 41 provides periodic heating (temperature oscillations) to the sample 46 via the film. The wavelengths of the emitted pump and probe beams 41, 43 are typically selected based on the transducer used, as each metal will have a different and thermo-optic coefficient absorption spectrum. The transducer material is selected to maximise the absorption of the pump beam, and also to maximise the temperature-sensitivity of the reflectivity of the probe beam.

As will be described further below, and as shown in FIGS. 10 and 12, in use, the pump beam is received by the sample 46. The sample 46, or the transducer (if present), absorbs at least part of the pump beam 41 thereby inducing temporal temperature oscillations within the sample. The pump beam 41, when incident on the sample 46, has a spot diameter and temporal intensity-oscillations sufficient to induce a measurable temperature oscillation in the sample that penetrates to a required depth within the sample. The system 10 further comprises a measurement apparatus which monitors the thermal response of the sample 46, determines the phase lag of the thermal response with respect to the pump beam 41, and then calculates one or more thermal properties of the sample 46. The measurement apparatus will now be described in more detail.

The measurement apparatus comprises probe diode 13a, probe driver 13b, and beam homogeniser 30b, along with a photodetector 80 and lock-in amplifier 70.

Since the surface reflectance properties of a sample are dependent on the temperature of the sample, the thermal response of the sample 46 can be determined by analysing the properties of a reflected probe beam 47 (shown in FIGS. 10 and 12). As such, the photodetector 80 is arranged to detect the probe beam 43 after reflection from the sample 46 in use. The photodetector 80 receives the reflected probe beam 47 and detects the intensity of the oscillations of the reflected probe beam 47, and from this, the thermal response of the sample 46 induced by the temporal intensity oscillations of the pump beam 41 can be detected.

The lock-in amplifier 70 (shown in FIG. 10) is electrically coupled to the photodetector 80. As shown in FIG. 10, the lock-in amplifier 70 receives, in use, a signal 48 from the photodetector 80 comprising the thermal response data, and then determines the phase lag of the probe beam intensity oscillations with respect to the pump beam intensity oscillations. The phase lag data can then be analysed to determine the thermal properties of the sample 46.

As best shown in FIGS. 1 and 2, the system 10 further comprises a baseplate 60 onto which the entire system 10 is mounted, including cooling fans 66. A further baseplate 64 is located above baseplate 60, and comprises all optical elements (including the beam homogenisers 30a, 30b, the optical arrangement 20, the objective tube 22) and the stage section 40. Between the two baseplates 60 and 64 are vibration isolating feet 62. The vibration isolating feet 62 act to vibrationally insulate the optical elements and stage section 40 from baseplate 60, which is in contact with the environment and vibration generating cooling fans 66, thereby helping to prevent mechanical vibrations from distorting the measured thermal response during use of the system 10. The example shown comprises two cooling fans 66, one for cooling the electrical side of the system and one for cooling the optical side of the system around the laser diodes 12a, 12b. The cooling fans 66 can be powered by a power supply 67, shown in FIG. 2.

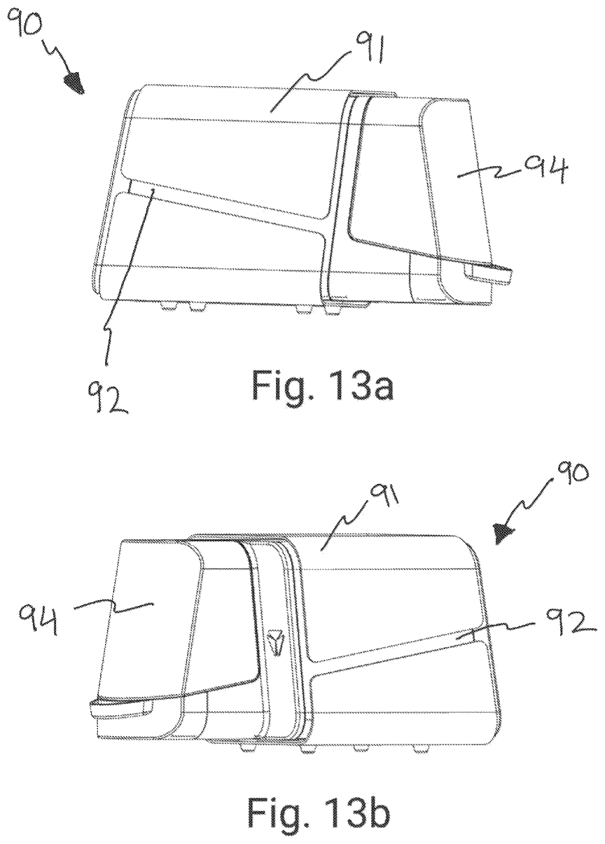

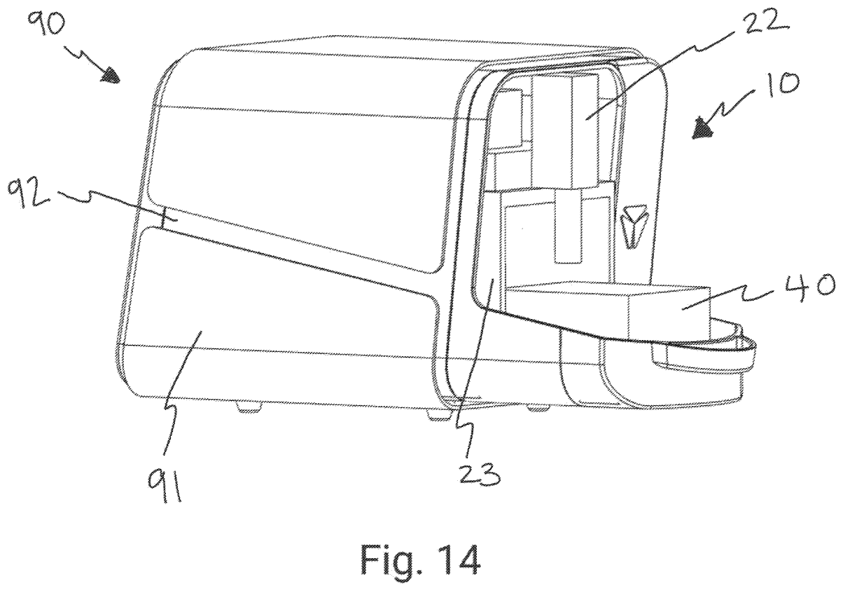

As shown in FIGS. 13a, 13b and 14, the system 10 can be housed in a Class 1 interlocked enclosure 90. The enclosure 90 comprises wall panels 91 and panel gaps 92. The panel gaps 92 are designed to allow airflow through the enclosure 90 in use, to help prevent the system 10 from overheating.

The enclosure 90 further comprises a door 94, shown in FIGS. 13a and 13b. The door has been removed in FIG. 14 to show the system 10 within the enclosure 90. The door 94 can be moved between a closed position (the operative position, shown in FIGS. 13a and 13b) and an open position (the non-operative position, not shown).

In some examples, the laser diodes 12a, 13a are automatically switched off if the door 94 is opened during operation. In other examples, the door 94 comprises a locking mechanism, which is controlled by an FDTR program 86. When the locking mechanism is in a de-activated state, the door 94 can be opened, and the system 10 cannot be operated. That is, the FDTR program 86 will not execute the program instructions whilst the door 94 is open. When the door 94 is closed, and the locking mechanism is in an activated state, the system 10 can be operated as described above. Once the system 10 is in operation, the locking mechanism cannot be de-activated, and the door 94 cannot be opened. The door 94 can only be opened once the system 10 has finished taking the required measurements, or a command to abort the program is received by an operator, and the laser diodes 12a, 13a are powered off. Such an interlocked enclosure 90 reduces the risk that the laser beams 41, 43 can be accessed during normal use, and therefore reduces the risk that an operator will experience eye damage. The system 10, when housed in a Class 1 interlocked enclosure 90, can safely be operated without protective goggles.

As shown in FIG. 10, the system 10 is in wired communication 87 with a computing device 85, such as a desktop computer or a laptop. An FDTR computer program 86 is installed on the computing device 85 which, when executed, displays a graphical user interface (GUI) on a screen of the computing device 85. An example GUI interface 81 is shown in FIG. 16. As shown in box 82, the interface 81 can receive information from an operator about the sample 46, such as the different layers present in the sample 46 and their composition, the known thermal conductivities of each of the layers present in the sample 46, and their thermal conductivities, densities, specific heat capacity, layer thickness, and thermal diffusivity. Where a parameter is unknown, such as the thermal conductivity or thermal diffusivity of one of the layers, this is entered as “unknown”. It is these unknown features which will be determined by the FDTR systems and methods described herein. It will be appreciated that other relevant parameters may also be entered into the interface 81 about each of the layers present. The operator can then initiate execution of the measurement process by clicking the “Start new measurement” button 83a in the top right corner of the interface 81. In some embodiments, if the measurement process has already begun, the operator can choose to stop the process by clicking the “abort” button 83b.

The FDTR program 86 comprises program instructions, which when executed after receiving sample information from the operator, makes the required measurements. As the data is collected, a graph 84a of the modulation frequency (x-axis) against the measured phase lag (y-axis) is generated and displayed on the interface 81. The interface 81 can also display a real-time camera feed 88a of the system 10 when in operation, and a progress bar 88b indicates the progress made. Once all the data is collected, the unknown thermal property (i.e., the unknown thermal conductivity and thermal diffusivity of a particular layer in the sample) is calculated from the graph 84a, and the results 84b can be displayed on the interface 81 for viewing by an operator. The data collected can also be saved and/or downloaded 89.

A non-limiting implementation of system 10 will now be described in use.

An operator begins by opening the door 94 of the enclosure 90, loading a sample 46 of a material onto the holder 42, and then closing the door 94 again. The sample 46 can comprise bulk, thick, thin film, and/or multilayer materials, and can have an optically smooth or an optically rough surface and/or lateral inhomogeneities. The sample may also have a curved surface.

The operator then starts the FDTR program 86 on the computing device 85 connected to the system 10, and inputs any required sample information into the GUI interface 81 displayed on the screen, such as the parameters described above, and indicates any unknown parameters. The operator can then initiate execution of the measurement process by clicking button 83a.

The FDTR program 86 first instructs the locking mechanism to activate, such that the door 94 cannot now be opened until the measurement process has finished. The measurement process is typically completed within 10 minutes, although this may be longer if the operator requires a two-dimensional map of the sample 46. The progress of the measurement process is shown on progress bar 88b.

Once the locking mechanism is active, the FDTR program 86 activates the laser diodes 12a, 13a to generate the pump and probe beams 41,43.

The signal generator 17 generates and delivers a modulation signal 49 to the pump diode driver 12a, which acts to modulate the current provided to the pump diode 12a, thereby modulating the intensity of the emitted pump beam 41. An intensity-modulated pump beam 41 is required to induce a temperature oscillation within the sample 46.

In contrast, the probe diode driver 13b is not coupled to the signal generator 17, and so a constant current is provided to the probe diode 13a. The probe diode 13a therefore emits a laser beam 43 having a constant intensity.

The motor is then instructed to move the holder 42 by the required amount in the X-, Y-, and Z-axes to position the sample 46 such that it is in the focus of the pump and probe beams 41, 43. In some implementations, the focus of the pump and probe beams lies around 20 mm from the end of the objective tube 22.

The intensity-modulated pump beam 41 is then received by the looped optical fibre cables 39 at the first end 31a of the beam homogeniser 30a, and the constant intensity probe beam 43 is received by the looped optical fibre cables 39 at the first end 31b of the beam homogeniser 30b. The pump and probe laser beams 41, 43 are guided around the loops of the corresponding optical fibre cable 39.

A component 38 impresses undulations along at least part of a loop from each cable 39, to help even out the distribution of modes within the pump and probe beams 41, 43, such that the pump and probe beams 41, 43 are more homogenised and circularised, upon exiting the beam homogenisers 30a, 30b.

The second ends 32a, 32b of the beam homogenisers 30a, 30b then steer the homogenised pump and probe beams 41, 43 towards the optical arrangement 20, where a series of optical devices shape, collimate, and steer the pump and probe beams 41, 43, as well as filter any undesired wavelengths from the beams 41, 43.

As shown in FIG. 11, the pump and probe beams 41, 43 travel along separate paths from the beam homogenisers 30a, 30b into the optical arrangement 20.

The probe beam 43 is first received by a beam splitter BS which is needed to separate the incident probe beam 43 from the reflected probe beam 47, and steers the incident probe beam 43 towards the dichroic mirror D.

The pump beam 41 is first received by a shortpass filter Fi to remove any unwanted wavelengths from the pump beam 41, and is then steered by mirror M towards a dichroic mirror D. The dichroic mirror D then steers the pump beam 43 such that it is aligned with the probe beam 41, and combines the optical paths of the beams 41, 43, such that they travel along the same path towards the sample 46.

The path combined (or co-axial) beams 41, 43 are then received by a mirror, “45 °M”, which is arranged at a 45 degree angle to the path of the combined beams. The mirror “45 °M” steers the path combined beams 41, 43 through a substantially 90 degree angle, such that the path combined beams 41, 43 travel co-axially through the objective tube 22. The beams 41, 43 travel through the objective lens 33, which is positioned such that the beams 41, 43 are focussed on the sample 46 with the required spot diameters.

As shown in FIG. 12, the path combined beams 41, 43 exit the objective tube 22, and are received by the sample 46 located on the holder 42. Since the beams 41, 43 are co-axial, they are received at the same location (spot) on the sample 46.

The pump beam 41 and the probe beam 43 have the same angle of incidence, which in this embodiment is normal to the surface of the sample 46. Once the probe beam 43, or both the pump and probe beams 41, 43, are incident on the sample 46, the motor can be instructed to make any required adjustments to the location of the sample 46 with respect to the beam(s) to ensure the sample 46 is in the focus of the pump/probe beam(s).

The pump beam 41 induces temperature oscillations within the sample 46, such as at the surface of the sample, or at a boundary or interface within the sample. Simultaneously, the probe beam 43 is reflected from the sample 46, such as from the surface of the sample, or from the boundary or interface within the sample. If the surface of the sample is irregular, such as optically rough, or laterally inhomogeneous, the larger probe spot diameter can measure the average thermal response, rather than the local response (as would be typical with much smaller probe beams).

As shown in FIG. 12, the probe beam is reflected 47 back along the normal to the surface of the sample, and is received by the objective tube 22. The reflected probe beam 47 then travels along the objective tube 22 towards the mirror “45 °M”, which steers the reflected probe beam 47 into the optical arrangement 20. The dichroic mirror D allows the reflected probe beam 47 to pass through and travel towards the beam splitter BS. The beam splitter BS then steers the reflected probe beam 47 through a 90 degree angle towards the photodetector 80. Prior to being received by the photodetector 80, the reflected probe beam 47 is passed through a focussing lens and a bandpass filter F2 to remove any unwanted wavelengths from the beam, such as any reflected wavelengths from the pump beam 41.

The system 10 is typically calibrated prior to measurement to help reduce the effect of any systematic phase shifts. Prior to measurement, a phase calibration curve may be recorded by removing the bandpass filter F2 and placing a highly reflective target (e.g., a mirror) on the holder 42 instead of a sample. The target will reflect the pump beam, and the reflected pump beam will be detected and measured by the photodetector 80. The pump phase is determined, and then this can be subtracted from the phase lag of the thermal response of a sample.

The photodetector 80 measures the intensity of the reflected probe beam 47 (the thermal response), which will vary depending on the temperature oscillations induced within the sample 46. These measurements are then transmitted 48 to the lock-in amplifier 70 (as shown in FIG. 5), which compares the thermal response signal to the pump beam 41 signal, determines the phase lag between them, and then transmits the phase lag data to the FDTR computer program 86. The phase lag calculations will normally account for any instrumental phase shift (the phase shift of the pump beam compared to the modulation signal).

The FDTR program 86 then instructs the lock-in amplifier 70 to change the frequency of the modulation signal 49 provided to the pump driver 12b, which will cause the intensity of the pump beam 41 to be modulated at a different frequency. The measurement process described above is then repeated for a number of different frequencies within a pre-defined frequency range-such as from 10 Hz to 10 kHz. The order of the frequencies chosen does not matter, but for convenience, the frequency is typically swept from one end of the range to the other, such as from low frequencies to high frequencies. The frequency range scanned is lower than the frequencies utilised by known systems. As such, system 10 is capable of probing deeper into a sample, for example to measure the thermal response of a boundary layer/interface deep within the material.

The lock-in amplifier 70 may be multichannel. By utilising a multichannel lock-in amplifier 70, phase lag data at multiple different frequencies can be measured at the same time, thereby reducing the execution time of the program.

The FDTR program 86 then plots a graph 84a showing phase lag (y-axis) versus frequency (x-axis). This graph 84a can be displayed on the computer screen for viewing by the operator. The plotted curve is then analysed, and the calculated value(s) for the unknown properties of the sample are determined. The results 84b are displayed on the screen.

In some implementations, the measurement process ends here. The determined thermal properties are then displayed on the computer screen for viewing by the operator. However, in other implementations, if the operator requires a two-dimensional map of the thermal properties, the motor is then instructed to move the holder 42, such that a second point on the surface of the sample 46 is in the focus of the beams 41, 43. The system 10 then repeats the measurement process at the second point. This process is repeated for many different points on the surface of the sample 46 until a two-dimensional map of the thermal properties has been created, and then displayed on the computer screen for viewing by the operator.

Once the system 10 is no longer in operation, the FDTR program 86 instructs the laser diodes 12a, 13a to shut down at the end of the measurement process, and also de-activates the locking mechanism so the operator can open the door 94 and remove the sample from the holder 42. If required, a new sample can be loaded onto the holder 42 and the whole process repeated for the new sample.

The operator has the option to download and/or store 89 the thermal property data for future reference. The data can be stored in non-volatile memory, such as solid-state drives, hard disk drives, optical disks, and flash drives.

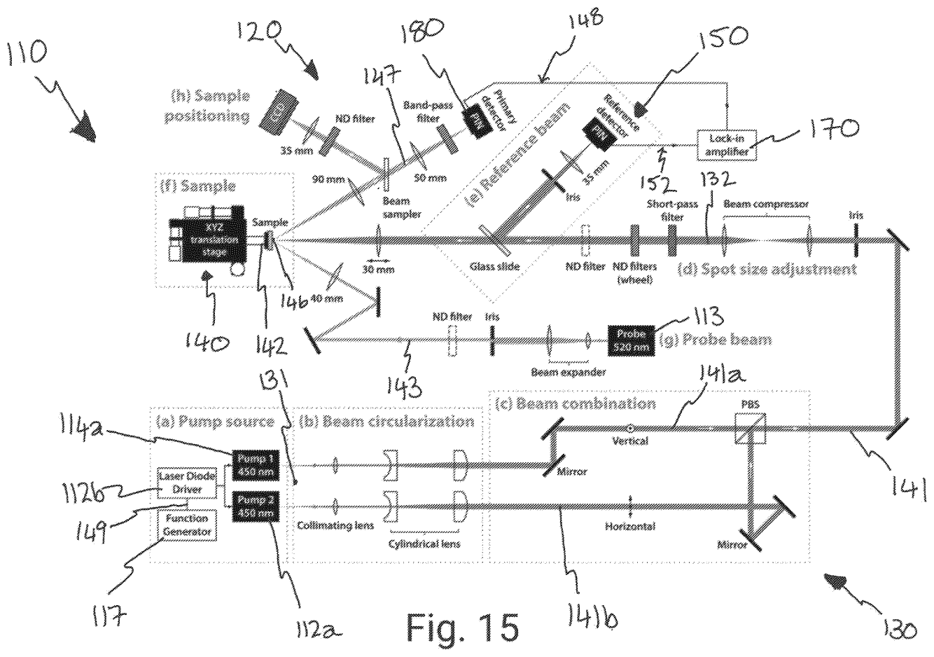

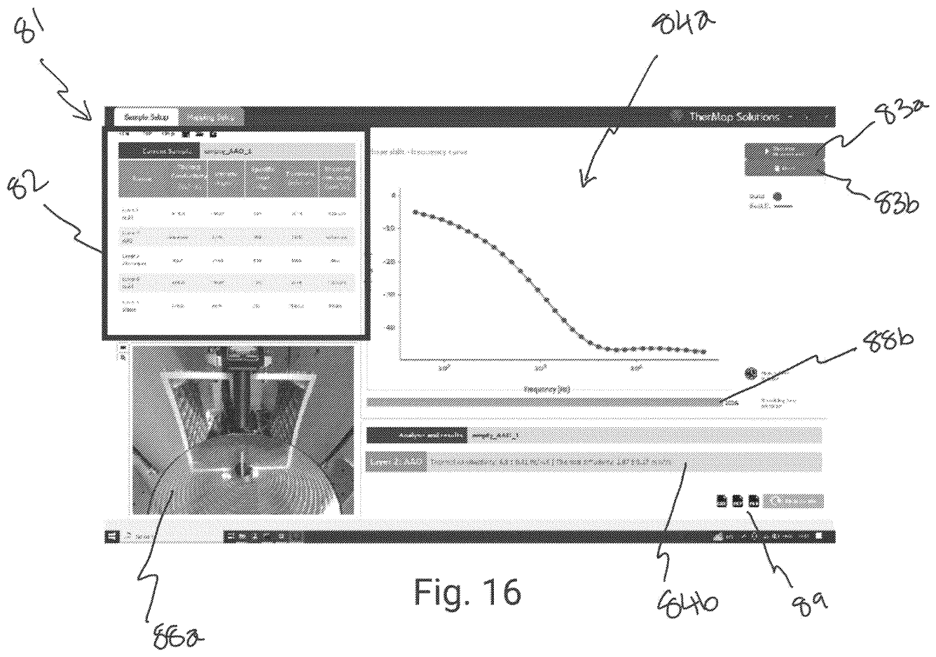

FIG. 15 shows a further embodiment of the invention. Where the features are the same as the embodiment described in FIGS. 1-14, the same reference numeral will be used except preceded by a “1”. Furthermore, unless otherwise stated, like components can be assumed to function in the same manner as the embodiment described above.

FIG. 15 shows a system 110 for measuring the thermal properties of a sample 146. The system 110 comprises two devices in the form of high-power laser diodes 112a, 114a which each emit a continuous-wave laser beam in use 141a, 141b. The emitted laser beams 141a, 141b are both pump beams.

The laser diodes 112a, 114a are electrically coupled to a laser diode driver 112b. Laser diode driver 112b is electrically coupled to a signal generator 117. In this example, the signal generator 117 is a separate component from a phase-sensitive detector 180, which again takes the form of a lock-in amplifier.

The signal generator 117 can take the form of a function generator. The function generator 117 provides a modulation signal 149 to the diode driver 112b, thereby generating intensity-modulated pump beams 141a, 141b. As described above, the intensity-modulated pump beams 141a, 141b, when incident on a sample 146, can induce temperature oscillations within the sample 146. In examples, the frequency of the modulation signal 149 can be varied in use from around 10 Hz up to 10 kHz.

The system 110 comprises a series of free-space optical devices which receive the pump beams 141a, 141b from the laser diodes 112a, 114a, and then steer the beams towards a sample 146, which is located on a holder 142 in a stage section 140. Some of the relevant free-space optics will now be described.

In step (a), the pump beams 141a, 141b are generated as discussed above.

In step (b), a spherical collimating lens is followed by a pair of cylindrical lenses associated with each laser diode 112a, 114a, to circularise the pump beams 141a, 141b. The spherical collimating lens acts to collimate the fast axis component of the beams 141a, 141b. Then a concave cylindrical lens expands the slow axis component of the beams 141a, 141b, followed by a convex cylindrical lens to collimate the slow axis component of the beams 141a, 141b.

In step (c), a polarising beam splitter “PBS” is used to combine the two pump beams 141a, 141b into a single but more powerful pump beam 141.

In step (d), the spot size and shape are adjusted. An iris is positioned after the polarising beam splitter “PBS” in the path of the combined pump beam 141, followed by a beam compressor, and a diffuser. In use, after combining the pump beams, the combined beam 141 is steered to the iris using two mirrors. The iris further shapes the beam and improves the circularisation. The beam compressor adjusts the diameter and shape of the combined pump beam, and the diffuser, which is located in the focus of the beam compressor, homogenises the combined pump beam 141.

Steps (b), (c) and (d) make up a beam homogeniser 130, which acts to shape and homogenise the pump beams 141a, 141b. The beam homogeniser 130 is optically coupled to the laser diodes 112a, 114a and is configured to receive the pump beams 141a, 141b in use, and guide the pump beams from the laser diodes 112a, 114a to an optical arrangement 120 (described below).

The beam homogeniser 130 comprises a first end 131 and a second end 132. The first end 131 is optically coupled to laser diodes 112a, 114a, and in use, receives the intensity-modulated pump beams 141a, 141b emitted from laser diodes 112a, 114a.

The second end 132 is optically coupled to the optical arrangement 120, and in use, steers the combined pump beam 141 towards the optical arrangement 120.

An optical assembly is arranged between the first end 131 and the second end 132. The optical assembly takes the form of a series of free space optical devices as described above in steps (b), (c), and (d). The optical assembly in steps (b), (c), and (d), are configured to interact with the pump beams 141a, 141b emitted from laser diodes 112a, 114a to form a combined pump beam 141 having a substantially rotationally symmetrical energy intensity distribution upon exiting the beam homogeniser 130 via the second end 132.

In use, the pump beams 141a, 141b can interact with the optical assembly to average the distribution of modes present in the combined pump beam 141, such that the combined pump beam 141 approaches a substantially rotationally symmetrical energy intensity distribution.

The remaining free-space optical devices make up the optical arrangement 120, which receives the pump beam 141 from the beam homogeniser 130. The remaining free space optical devices which make up the optical arrangement 120 will now be described. The combined pump beam 141 exits from step (d), and is transmitted to a short-pass filter, which ensures that no light other than the combined pump beam 141 is steered towards the sample 146. The combined pump beam 141 is then steered through ND filters, which provide the ability to adjust the power of the combined pump beam 141, thereby adjusting the heating power of the combined pump beam 141 to help avoid excessive heating of the sample 146.

The combined pump beam 141 is then received by a beam sampler in step (e), which is used to split off a portion of the combined pump beam 141 (around 1-2%), and steer this portion to a reference detector 150. The reference detector 150 is typically a photodetector. The reference detector 150 measures the intensity of the sampled pump beam, and transmits this information to the lock-in amplifier 170 in the form of a reference signal 152. The reference signal 152 can be used to determine the phase shift of other incoming signals, such as the phase shift of the probe beam signal. The embodiment described in FIGS. 1-9 does not specifically include a reference detector, as the reference signal is provided by the internal reference oscillator of the lock-in amplifier 70.

The optical arrangement 120 steers the combined pump beam 141 towards a sample 146 located on the holder 142 in the stage section 140. The combined pump beam 141 has an average optical power output of up to several Watts, and a spot diameter of at least 75 microns, optionally at least 100 microns, when incident on the sample 146.

The system 110 further comprises an objective tube 122. In use, the holder 142 is positioned directly below the objective tube 122. The holder 142 is configured to receive and hold a sample 146 of material in use. The holder 142 is operatively coupled to a motor (not shown), which, in use, moves the holder 142 in the X-, Y-or Z-directions (that is, horizontally and vertically) to position the sample 146 in the focus of the combined pump beam 141. In use, the combined pump beam 141 is received by the sample 146. The sample 146 absorbs at least part of the pump beam 141 thereby inducing temperature oscillations within the sample 146. The combined pump beam 141, when incident on the sample 146, has a spot diameter of at least 75 microns.

The system 110 is designed to receive and analyse samples having a thickness (along the Z-axis) of tens of microns up to several millimetres, and measuring up to 200 mm along the X-and/or Y-axis. In some implementations, the sample of material comprises a thin film metal transducer extending across the X-Y surface of the sample. The system 110 further comprises a measurement apparatus which monitors the thermal response of the sample 146, determines the phase lag of the thermal response with respect to the pump beam 141, and then calculates one or more thermal properties of the sample 146. The measurement apparatus will now be described in more detail.

The measurement apparatus comprises a probe device 113 in the form of a laser diode configured to emit a further continuous wave laser beam in the form of a probe beam 143. The probe beam 143 is configured to reflect from the sample 146, the surface reflectance properties of the sample being dependent on the temperature of the sample 146, such that the probe beam 143 is configured to detect the thermal response of the sample due to the temperature oscillations induced by the combined pump beam 141.

The measurement apparatus further comprises photodetector 180 and lock-in amplifier 170. Since the surface reflectance properties of a sample 146 are dependent on the temperature of the sample, the thermal response of the sample can be determined by analysing the properties of the reflected probe beam 147. As such, the photodetector 180 is arranged to detect the probe beam after reflection from the sample 146 in use. The photodetector 180 receives the reflected probe beam 147 and detects the intensity of the reflection from the sample, and from this, the thermal response of the sample 146 due to the temperature oscillations induced by the pump beam 141 can be determined.

The lock-in amplifier 170 is electrically coupled 148 to the photodetector 180. The lock-in amplifier 170 is configured to receive a signal from the photodetector 180 comprising the thermal response data, and a reference signal 152 from the reference detector 150, and then determine the phase lag of the thermal response with respect to the combined pump beam 141.

The optical arrangement 120 further comprises a series of optical devices located between the laser diode 113 and the sample 146. The series of optical devices receives a probe beam 143 from diode 113, as will be described below, and manipulates the properties of the probe beam 143 and steers the probe beam 143 towards the sample 146. The probe beam 143 is not specifically homogenised prior to being steered towards the sample since the spot diameter is much smaller than the pump spot diameter. In this example, the probe beam 143 has a spot diameter of at least 10 microns when incident on the sample 146.

The optical arrangement 120 further comprises a series of optical devices located between the sample 146 and the photodetector 180. The series of optical devices receives the probe beam 143 after reflection from the sample 146, and steers the reflected probe beam 147 towards the photodetector 180. A further beam sampler is located in the path of the reflected probe beam 147 to split off a portion of the reflected probe beam 147, and steer this portion to a CCD camera shown in step (h). Step (h) monitors the focus and position of the sample 146 with respect to a probe beam 143, and can indicate if any repositioning of the sample 146 is required.

In use, the optical arrangement 120 is configured to steer the combined pump beam 141 and the probe beam 143 towards the stage section 140. The optical arrangement 120 and objective tube 122 are configured to steer the combined pump beam 141 towards the sample 146 at a first angle of incidence. The optical arrangement 120 is further configured to steer the probe beam 143 towards the sample 146 at a second angle of incidence which is greater than the first angle of incidence (i.e., a split-axis configuration). In contrast to FIGS. 1-9, the probe beam 143 is not incident along the normal of the sample 146, and so is reflected at an angle to the normal.

In use, the method for determining the thermal properties of the sample 146 based on a graph of the phase lag versus frequency is the same as described above with regard to FIGS. 1-14.

Whilst the principle of the invention has been illustrated using exemplary embodiments, it will be understood that the invention is not limited to exemplary embodiments and that the invention may be embodied by other variants defined within the scope of the appended claims.

1. A frequency-domain thermoreflectance (FDTR) system for measuring the thermal properties of thermally conductive and/or optically rough materials, the system comprising:
a pump device having an adjustable power output, and configured to emit a continuous-wave laser beam; the laser beam being referred to as a pump beam;
a signal generator configured to generate a modulation signal to temporally vary the intensity of the pump beam emitted from the pump device;
an optical arrangement configured to receive and shape the pump beam, and steer the pump beam towards a sample of a material, such that the pump beam interacts with the sample in use; and,
a measurement apparatus configured to monitor the thermal response of the sample due to interaction with the pump beam;
wherein the pump beam, when incident on a sample, has a spot diameter and a temporal intensity-oscillation sufficient to induce a measurable temperature oscillation in the sample that penetrates to a required depth within the sample.

2. A system as claimed in claim 1, wherein, when incident on the sample, the pump beam has a spot diameter of at least 400 microns.

3. A system as claimed in claim 1, wherein the pump beam is configured to have a spot diameter, when incident on a sample, of at least 50 microns.

4. A system as claimed in any preceding claim, wherein the pump device is electrically coupled to a driver, and the driver is electrically coupled to the signal generator; and wherein the signal generator is configured in use to deliver a modulation signal to the driver to modulate the current provided to the pump device, thereby modulating the intensity of the emitted pump beam, and inducing a temperature oscillation within the sample; and wherein the frequency of the modulation signal is variable within a pre-defined range.

5. A system as claimed in any preceding claim, wherein the measurement apparatus comprises:
a probe device configured to emit a further continuous wave laser beam; the further laser beam being referred to as a probe beam; and,
wherein the probe beam is configured to reflect from the sample, the reflectance properties of the sample being dependent on the temperature of the sample, such that the temperature oscillations induced within the sample by the pump beam can cause the intensity of the reflected probe beam to oscillate temporally.

6. A system as claimed in claim 5, wherein the thermal response of a sample is monitored by detecting the intensity of the reflected probe beam, and measuring the phase lag of the probe beam intensity oscillations with respect to the pump beam intensity oscillations.

7. A system as claimed in either claim 5 or claim 6, wherein the probe beam is configured to have a spot diameter, when incident on a sample, of up to 10 microns.

8. A system as claimed in either claim 5 or claim 6, wherein the probe beam is configured to have a spot diameter, when incident on a sample, of at least 50 microns.

9. A system as claimed in any preceding claim, further comprising a pump beam homogeniser optically coupled to the pump device; the beam homogeniser being configured to receive the pump beam emitted from the pump device; and wherein the pump beam homogeniser comprises:
a first end optically coupled to the pump device; the first end configured to receive the pump beam emitted from the pump device;
a second end optically coupled to the optical arrangement; the second end configured to steer a homogenised pump beam towards the optical arrangement; and,
an optical assembly arranged between the first end and the second end; the optical assembly configured to interact with the pump beam emitted from the pump device to form a homogenised pump beam having a substantially rotationally symmetrical energy intensity distribution upon exiting the pump beam homogeniser via the second end.

10. A system as claimed in claim 9, wherein the optical assembly of the pump beam homogeniser comprises an optical fibre cable; and wherein the optical fibre cable comprises undulations located along at least part of the length of the optical fibre cable.

11. A system as claimed in claim 10, wherein the optical assembly further comprises a component having an undulating surface pattern arranged to receive and interact with at least part of the optical fibre cable to induce an undulating profile into the shape of the optical fibre cable.

12. A system as claimed in claim 11, wherein the optical assembly of the pump beam homogeniser comprises one or more free-space optical devices arranged to interact with the pump beam to form a homogenised pump beam having a substantially rotationally symmetrical energy intensity distribution upon exiting the pump beam homogeniser via the second end.

13. A system as claimed in any one of claim 5 to claim 8, wherein the measurement apparatus comprises a probe beam homogeniser optically coupled to the probe device;
the probe beam homogeniser being configured to receive the probe beam emitted from the probe device; and wherein the probe beam homogeniser comprises:
a first end optically coupled to the probe device; the first end configured to receive the probe beam emitted from the probe device;
a second end optically coupled to the optical arrangement; the second end configured to steer a homogenised probe beam towards the optical arrangement; and,
an optical assembly arranged between the first end and the second end; the optical assembly configured to interact with the probe beam emitted from the probe device to form a homogenised probe beam.

14. A system as claimed in claim 13, wherein the optical assembly of the probe beam homogeniser comprises an optical fibre cable; and wherein the optical fibre cable comprises undulations located along at least part of the length of the optical fibre cable.

15. A system as claimed in claim 14, wherein the optical assembly further comprises at least one component having an undulating surface pattern arranged to receive and interact with at least part of the optical fibre cable to induce an undulating profile into the shape of the optical fibre cable.

16. A system as claimed in claim 13, wherein the optical assembly of the probe beam homogeniser comprises one or more free-space optical devices arranged to interact with the probe beam to form a homogenised probe beam having a substantially rotationally symmetrical energy intensity distributions upon exiting the probe beam homogeniser via the second end.

17. A system as claimed in any one of claim 13 to claim 16, wherein the optical arrangement comprises a plurality of free-space optical devices configured to receive and shape the pump and/or probe beam from the pump and/or probe beam homogenisers, respectively, and steer the pump and/or probe beam towards a sample.

18. A system as claimed in claim 17, further comprising an objective tube configured to receive the pump and/or probe beam from the optical arrangement, and steer the pump and/or probe beam towards the sample.

19. A system as claimed in either claim 17 or claim 18, wherein the optical arrangement is configured to steer the pump beam towards the sample at a first angle of incidence, and steer the probe beam towards the sample at a second angle of incidence;
and wherein the first and second angles of incidence is arranged to be the same, or arranged such that the second angle of incidence is greater than the first angle of incidence.

20. A system as claimed in any one of claim 5 to claim 19, wherein the measurement apparatus further comprises a photodetector configured to receive the reflected probe beam, and detect the intensity of the reflected probe beam.

21. A system as claimed in claim 20, wherein the measurement apparatus further comprises a phase-sensitive detector electrically coupled to the photodetector and the signal generator, and configured to determine the phase lag of the reflected probe beam intensity with respect to the pump beam intensity.

22. A self-contained frequency domain thermoreflectance unit, the unit comprising:
an enclosure configured to selectively move between an operative position and a non-operative position; and,
the system as claimed in any one of claim 1 to claim 21 housed within the enclosure;
wherein in the non-operative position the enclosure can be opened to expose at least part of the system for loading a sample onto the holder; and in the non-operative position the enclosure completely encapsulates the system.

23. A method of performing a frequency-domain thermoreflectance measurement using the system as claimed in any one of claims 1 to 21, the method comprising:
receiving a sample of a material;
generating a continuous-wave laser beam; the laser beam being referred to as a pump beam;
temporally modulating the intensity of the pump beam, homogenising, and shaping the pump beam, and steering the pump beam onto the sample; wherein the pump beam, when incident on the sample, has a spot diameter and an intensity-oscillation sufficient to induce a measurable temperature oscillation in the sample that penetrates to a required depth within the sample;
generating a further continuous-wave laser beam, the further laser beam being referred to as a probe beam;
reflecting the probe beam from the sample and monitoring the thermal response of the sample by detecting the temporal intensity oscillations of the reflected probe beam; and,
measuring the phase lag of the probe beam intensity oscillations with respect to the pump beam intensity oscillations.

24. A method as claimed in claim 23, further comprising:
varying the temporal frequency of the modulation signal within a pre-defined range, thereby generating different pump beams with different temporal intensity oscillations, such that different temperature oscillations are induced within the sample;
monitoring the thermal response of the sample by detecting the intensity of the reflected probe beam ;
measuring the phase lag of the reflected probe beam intensity with respect to the pump beam intensity oscillation, at a number of different modulation frequencies within the pre-defined range;
deriving the thermal properties of the sample from the phase lag measured at each modulation signal frequency.

25. A computer system for determining the thermal properties of a thermally conductive and/or optically rough material, the computer system including at least one processor for executing program instructions configured to:
receive properties relating to a sample of a material;
perform the method as claimed in claim 24;
receive the thermal response of the sample, the thermal response comprising the temporal intensity oscillations of the reflected probe beam;
determine at least one thermal property of the sample from the phase lag of the probe beam intensity oscillations with respect to the pump beam intensity oscillations; and,
display the at least one thermal property of the sample on a display device for viewing by an operator.
